(19) United States
(12) Patent Application Publication
(10) Pub. No.: US 2006/0242652 A1
(43) Pub. Date: Oct. 26, 2006

(54) Configurable alert notification system and method

(76) Inventor: Thomas Stearn, Wharton, NJ (US)

Correspondence Address: Raymond Jones;IP Law Global, P.C., Suite 550 - PMB 5537, 11921 Freedom Drive, Reston, VA, 20190, US

(21) Appl. No.: 11/113,279

(22) Filed: Apr. 25, 2005

(51) Int. Cl. G06F 9/46

(52) U.S. Cl. 719/318; 370/485

(57) ABSTRACT

A configurable alert notification communications system including an audio receiver for detecting a discrete signal transmitted by a message dispatch system, and a computer connected to the audio receiver for recording, in a first format, an audio message associated with the discrete signal. The audio message in the first format can be converted to at least one of a plurality of dissimilar formats, and it can be further converted to a new format different from the dissimilar formats as specified by an end user company. The one or more formats are sent to corresponding servers configured to accept these formats, which are in turn transmitted to a recipient on the mobile device of his choosing.

### BACKGROUND OF THE INVENTION

1. Field of the Invention

The present invention relates generally to emergency responder notification systems, and more particularly to a configurable system and method designed to allow an individual to select and receive notification of alerts on any mobile device that is independently addressable, utilizing radio broadcasts from existing dispatching facilities, and making those alerts available for audible review via either an audio file on the web, a telephone call, an email attachment, or other existing or future transmission avenues.

2. Description of the Related Art

Many radio transmitters and receivers share a common frequency. In this arrangement, anything being transmitted on this frequency can be ‘picked up’ by any receiver tuned-in to the same channel. However, there are times when a transmitted signal is intended for a specific receiver. To ensure that the target receiver is the only one to receive the message, tone signaling is employed. Many pagers and other radio-controlled equipment used in public safety functions utilize broadcasted audio tones to select specific devices that share a common radio frequency.

In this basic method of encryption, a device called an encoder broadcasts tones. When the receiver picks up the tones, a decoder analyzes them. If the transmitted tones match the tones stored in the decoder, then it successfully ‘wakes up’ the target receiver. If the tones do not match the decoder's programming, then the transmitted signal is ignored.

Generally, all of these pager systems use a signaling format known as 2-tone sequential paging, alternately known as a 2-tone, Type 99, or Quick-Call II. This format is used to allow a dispatch center to send a selected code address to an individual pager or a group of users with a common address code. The code consists of two tones (known as A and B tones) set in a sequence. Typically, the duration of the first tone will be one second or less and the second tone will be three seconds or less. The tones normally fall within a range 300 to 3000 Hz, which means they are audible. The codes are identified by a frequency such as 539.0 or 1122.5. This is the actual frequency in Hertz (Hz or cycles) of the tone. When a properly coded signal is sent from the dispatch, the pager assigned to that tone activates and allows reception of the message sent by the dispatcher. The common providers of 2-tone systems include Motorola, Plectron and Zetron among others.

Certain systems comprise what is known as Message Alert receivers, whereby the unit responds to a specific tone code address, activates, and remains activated until the received message is finished. When the transmitting station at the dispatch center ceases to transmit, a hissing noise is heard on the receiver that indicates the message is complete. The user then resets his or her receiver to await the next dispatch call. The Message Alert receivers are not designed for continuous monitoring. Continuous channel monitoring is best suited to scanners, mobile/base, handheld portable radios or pagers specifically designed for this purpose.

Other pager systems have the combined capability to function either as Message Alert or Continuous Monitor receivers. The advantage of these receivers is the ability to function as an alerting receiver plus the ability to receive additional information enroute or at the scene without additional tone code or additional tone code activation at the dispatch center.

Of course, there are other methods of paging and signaling using digital encrypted technology, which is more advanced than the audio tone signaling. Examples of devices that use higher levels of security include alphanumeric pagers, digital cell phone technology, satellite transmissions, and the like.

The problem with all conventional alert systems is they are optimized for a particular transmission medium/mode or format, for example, cellular or text pager. This optimization results in a fixed hardware/software solution that is difficult to reconfigure, upgrade and adapt as new transmission avenues and formats are developed and deployed.

What is needed, therefore, is a flexible, configurable notification system comprising hardware and software that can convert messages to a variety of different formats for transmission, to ensure the best possible rate of recipient contact. What is also needed is a system that is readily adaptable and easily upgraded to add and accommodate new transmission formats and modes, and provide the recipient with a means to select the preferred types of transmission mode to ensure the best possible rate of recipient contact.

### SUMMARY OF THE INVENTION

To overcome the above described and other disadvantages of the prior art, embodiments of the invention allow for flexibility in recording an initial audio format of a detected message, flexibility in specifying and selecting any number of subsequent audio conversion formats, as well as flexibility in specifying and selecting the transmission mode and notification possibilities. This allows the configurable alert notification communications system and method described herein to be customized for each end user company's requirements, without having to install new hardware and other system components.

More specifically, embodiments of the invention described herein provide for a configurable alert notification communications system and method, comprising an audio receiver for detecting a discrete signal transmitted by a message dispatch system; a computer connected to the audio receiver for recording an audio message associated with the discrete signal in a first format; means for converting the audio message in a first format to at least one of a plurality of existing dissimilar formats as specified by an end user company, wherein the means for converting is also adaptable to convert the first format to a new format different from the dissimilar formats as specified by an end user company; means for distributing the first format, and the at least one dissimilar format or the new format, to corresponding server means configured for accepting each of the formats; and means for transmitting one or more of the formats from the server means to corresponding receiving means, wherein the receiving means are specified by the end user company and selected by a recipient.

### BRIEF DESCRIPTION OF THE DRAWINGS

The above objects and other advantages of the present invention will become more apparent by describing in detail the preferred embodiments thereof with reference to the attached drawings in which:

FIG. 1 is a schematic diagram of certain functional components of an embodiment of a configurable alert notification communications system;

FIG. 2 is a flow diagram for a software procedure running on the computer system in FIG. 1;

FIG. 3 is a detailed flow diagram of the detection procedures of FIG. 2;

FIG. 4 is a detailed flow diagram of the recording and conversion procedures of FIG. 2;

FIG. 5 is a detailed flow diagram of the delivery procedures of FIG. 2;

FIG. 6 is a detailed flow diagram of the transmission mode procedures of FIG. 2;

FIG. 7 is an exemplary screen shot of the various selectable functions made by an end user company or agency to customize the alert notification system; and

FIG. 8 is an exemplary screen shot of the various transmission and notifications functions capable of being selected by the recipient.

### DESCRIPTION OF PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Broadly described, an embodiment of the invention provides for an emergency responders alert notification and communications system where the system detects distinct audio tones and records messages associated with those tones, converts these messages to a plurality of message formats, with the capability to convert these messages to new and emerging formats as needed, and then transmits these messages to the appropriate recipients.

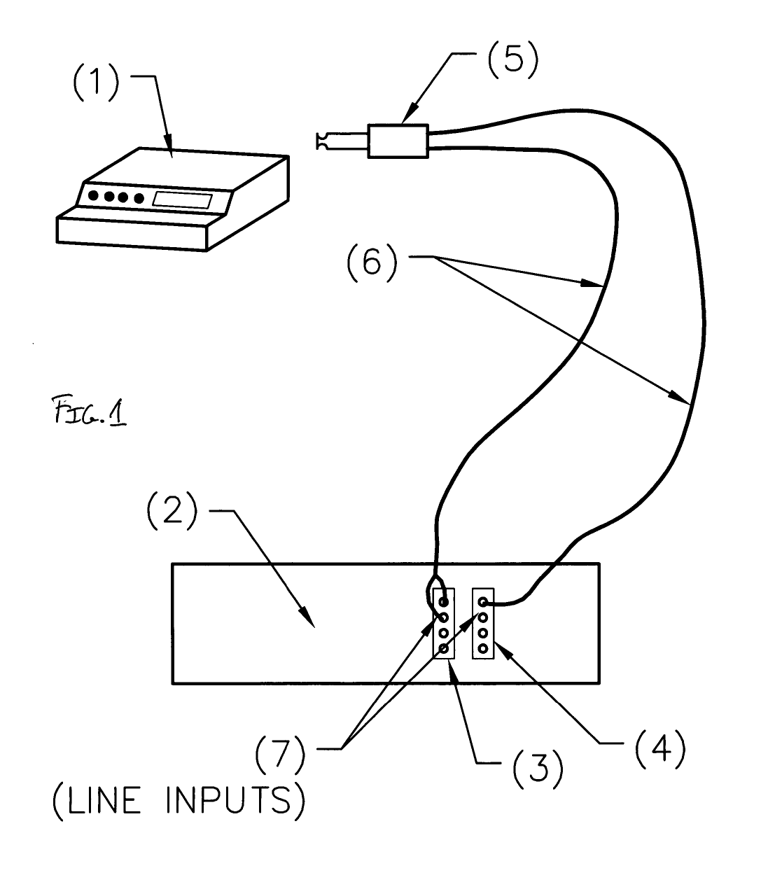

FIG. 1 depicts a communications system infrastructure usable with the invention. An audio receiver 1, for example, a Radioshack Pro-2018 or one of equivalent functionality, is set to the desired audio channel for reception. The audio receiver 1 is connected to a conventional computer 2 (the detecting computer), for example, a Dell Optiplex 170 or one of equivalent functionality, configured with two sound cards, a detecting sound card 3 and a recording sound card 4. The soundcards 3 and 4 may be for example, those provided by SoundBlaster, or equivalent soundcards, and including sound cards utilizing any and all computer bus architectures, including, but not limited to PCI ((Peripheral Component Interconnect), ISA (Industry Standard Architecture), MCA (Micro Channel Architecture), USB (Universal Serial Bus), etc)). This invention can include the capabilities of performing both the detecting task and the recording task with only one sound card, when and if the technology becomes attainable.

Preferably the computer system 2 is running any Unix-equivalent operating system, including but not limited to a Linux-based operating system, such as Mandrake Linux 10.0. It is understood, however, that the present invention can be adapted to function with any operating system (e.g., Windows, Macintosh, Solaris, etc.) within the scope of this invention. The audio receiver 1 is connected via its audio output jack to a splitter 5, and the split lines 6 are then connected into the Line-In ports 7 on each of the soundcards 3 and 4, respectively.

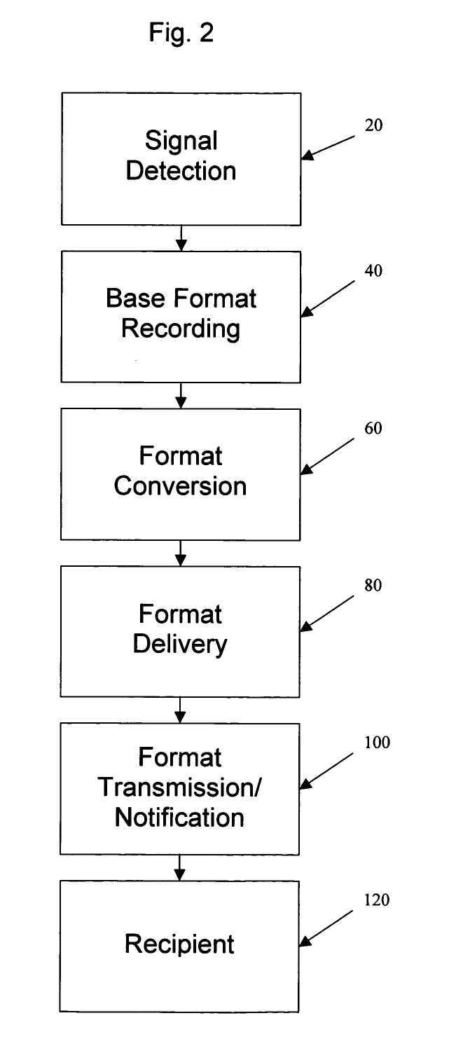

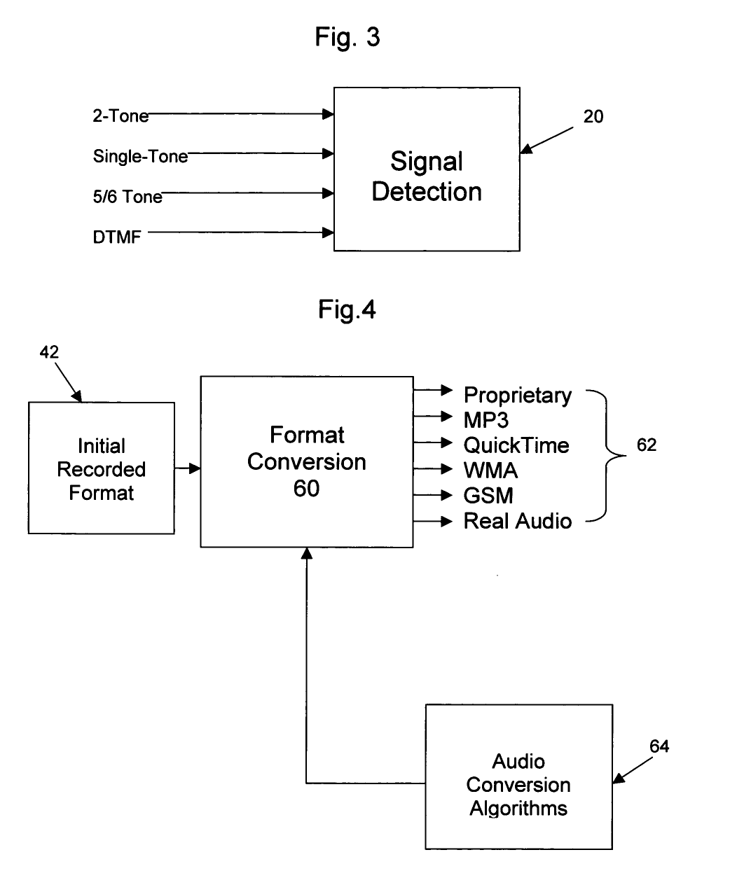

FIG. 2 provides a functional flow diagram of the main steps of the present invention, comprising a configurable alert notification communications software program loaded on the detecting computer 2. The communications software is preferably configured in the signal detection step 20 to listen for certain sets of two-tone sequences. It is understood that the software may be configured to listen for other tone triggers, such as single tone, group call, 5/6 tone, and DTMF (Dual Tone Multi-Frequency) among others within the scope of this invention as shown in FIG. 3. The software is designed to monitor the output of an external audio device (such as the audio receiver 1, commonly called a scanner). When the audio output matches any one of the preconfigured tones, the following process occurs.

In detecting Step 20, the detecting computer 2 samples the audio provided by the detecting sound card 3. The detecting software acts to detect the presence of any one of a number of preconfigured tone groups. These tones groups are the standard format by which emergency agencies are typically dispatched, such as Motorola's Quick Call II paging format. Once a preconfigured tone group is detected, in the recording Step 40, the detecting computer will make a base format recording of the output of the audio receiver for a specific amount of time (typically 45 seconds, although this time may be increased or decreased within the scope of this invention) from the recording sound card 4. The recording takes place in an initial format 42 (see FIG. 4), for example, a WAV format (WAV) because of its universality as the default format for digital audio on Windows computers, although other audio formats are contemplated within the scope of this invention. The system and process of this invention can be readily configured and optimized to handle either widely available audio formats, or specialized formats endemic to a single user organization, which for security reasons are kept proprietary. Such configurability is achieved by updating the software with a new audio conversion algorithm 64 to handle the conversion formatting as described further below.

After the initial audio format 42 (WAV file) is created, it is converted in Step 60 to the any number of dissimilar formats 62 as shown in FIG. 4 for example, such as the MP3 audio format (MP3), WMA (Windows Media Audio), which is Microsoft's proprietary audio codec designed to compete with MP3, Quicktime (Apple proprietary), RealAudio (RealNetworks proprietary), GSM (Global System for Mobile Communications), a digital standard for cellular phone communications that is used in many countries with communications bands ranging from 900-1800 MHz, or OGG. OGG is a fully open, non-proprietary, patent-and-royalty-free, general-purpose compressed audio format for mid to high quality (8 kHz-48.0 kHz, 16+ bit, polyphonic) audio and music at fixed and variable bit rates from 16 to 128 kbps/channel, which is designed to compete with the MP3 format. Other digital cellular standards in the United States include TDMA, CDMA and PCS. Moreover, satellite audio formats, such as Direct Broadcast Satellite (DBS) and other emerging digital satellite formats are also contemplated with the scope of the present invention. Again, the system and process of this invention can be readily configured, customized and optimized to convert to a wide variety of common or specialized formats specified by the end user using the appropriate audio conversion algorithm 64 in FIG. 4, and such conversion flexibility is achieved by updating the software with a new audio conversion algorithm 64 to handle the conversion formatting. One of ordinary skill would understand that existing audio conversion algorithms might be used, as well as new conversion algorithms being developed and incorporated in the invention. Note also the conversion Step 60 may be bypassed if the recipient merely needs to receive the audio file in the initial format 42.

The delivery of the software audio conversion 64 updates could be handled in several ways, depending on the desires of the end user company or agency and the computer configuration at the end users site. In an embodiment where the detecting computer 2 is installed at the end user's site, updates could be stored on a CD or similar medium and sent to the end user company or agency for updating, or the updates could be downloaded from a central web server communicating with the detecting computer 2. In an embodiment where the detecting computer 2 was part of an off-site central server network (and accessed remotely by the end user), the updates could be installed directly on the central off-site server.

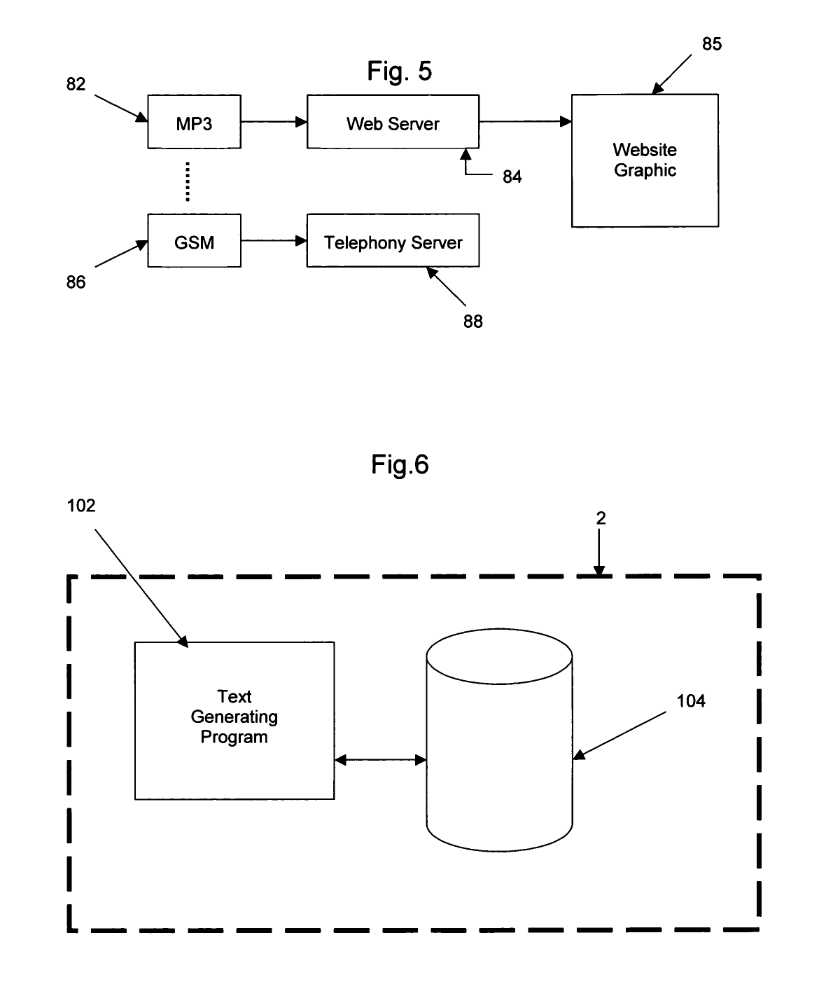

Returning to FIG. 2, in a distribution Step 80, the converted audio files, which are stored on a central repository on the detecting computer 2, are distributed to the appropriate severs. For example, as shown in FIG. 5, the MP3 file 82 is sent to a centrally located web server computer 84 running any type of web server software, such as the Apache Foundation's Apache Web Server. The web server 84 is then updated to display the new audio file on its website 85, along with any and all other MP3 files 82 from other detections.

The ability to view lists of audio files and then listen to them at a dedicated web site 85, which would usually be password/security protected as well, has distinct advantages over email transmission of alerts only. First, the ability to go to a single web site 85 simplifies the process of reviewing messages, as it can be done instantaneously from any operating computer. While email transmissions can be instantaneous in most cases, certain file attachments may not be amenable to viewing/listening on any computer, even if an end user's email could be accessed on that particular computer. In addition, current email security protocols force the email though various virus, spy ware, ad ware and other filters, slowing down the process. Moreover, the filtering process may inadvertently block the email from reaching its destination. Another drawback to email is that in times of crisis, where one form of communication is disabled, such as cellular phone coverage, the email systems may be over-burdened resulting in delays in receipt, which would definitely impact response time by emergency responders, for example.

As is also shown in FIG. 5, a GSM file 86 could be sent to a centrally-located telephony server computer 88 running a telephone system, such as Asterisk, an Open Source VOIP telephony product, to be made available for retrieval by an inbound telephone call. This GSM file could overwrite any existing file.

While distribution of MP3 and GSM files has been described in FIG. 5, it is understood that any of the other audio formats specified by the end user would be distributed to the appropriate server capable of handling one or more of the audio formats.

In the transmission/notification Step 100 of FIG. 2, the detecting computer 2 then runs a text-generating program 102 remotely on a centrally located database 104, either in the detecting computer 2 or other computer as shown in FIG. 6. The text-generating program 102 performs a query on the database contained thereon, such as the Open Source database server such as MySql or other conventional or proprietary database, to determine the email addresses or other transmission mode addresses of recipients who wish to be notified for this particular dispatch, based on the alert heard by the detecting computer 2, and the preferred transmission/notification mode for the recipient.

Once the addressees are determined, an SMTP (Simple Mail Transfer Protocol) email is generated, for example, and sent to the resulting list, containing the name of the particular agency that has received a dispatch, a telephone number to call, and a code unique to that agency. As shown in Step 120, the recipient receives the notification on their mobile device of an alert. The email recipient would then call that telephone number, and, when prompted, dial in the code. The recording would then be played, and the recipient would then hear the messaged that was dispatched. Other email protocols may be employed exclusively or in conjunction with the SMTP emails, such as POP (Post Office Protocol), MIME (Multipurpose Internet Mail Extension), and others. Alternately, as described above, email recipients could merely visit the web site 85 to download and play the recording.

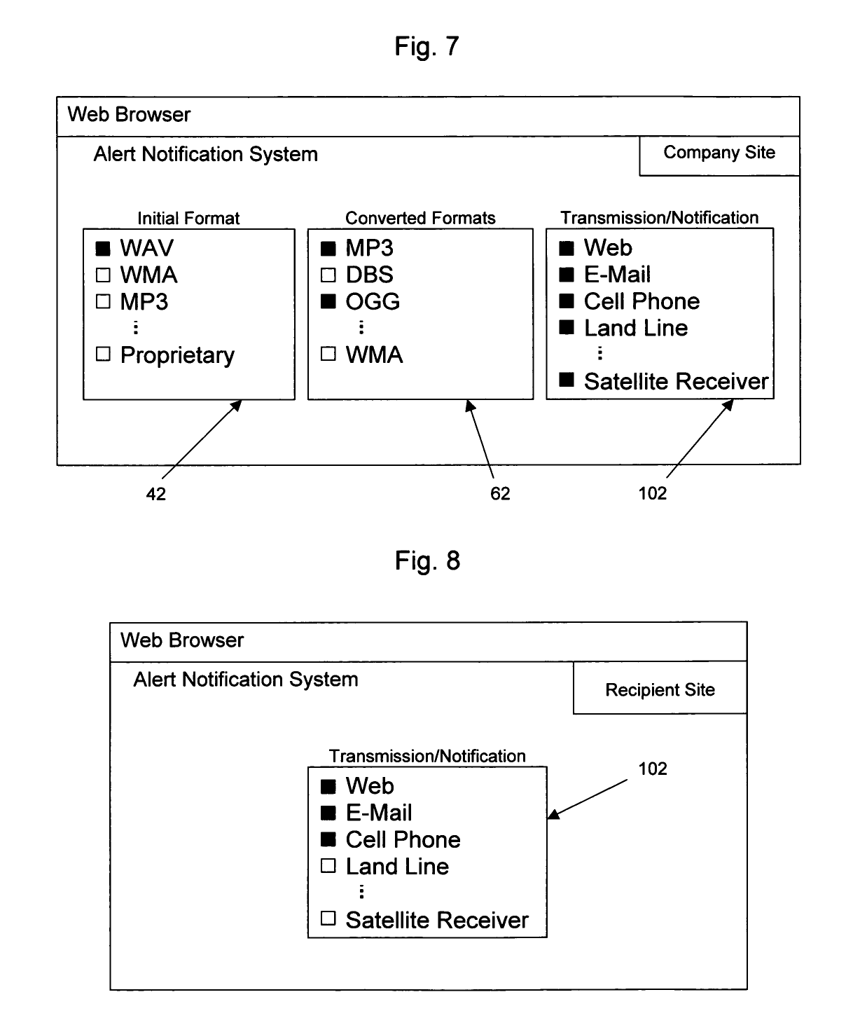

As described above, embodiments of the invention allow for flexibility in the initial audio format 42 for recording the message (Step 40), flexibility in the audio conversion formats 62 (Step 60) and the corresponding format delivery options to respective servers (Step 80), as well as flexibility in the transmission/notification possibilities 102 (Step 100). This allows the configurable alert notification communications system and method of the present invention to be customized for each end user's requirements, without having to install new hardware and other system components. To facilitate the customization process, another software program running on the detecting computer 2, or a central web server, can offer the options available to the end user (either the end user company/agency or the individual responder) as shown in FIG. 7.

In most cases during setup, an end user company or agency would ascertain their preferred audio recording formats, conversion formats, format delivery options and possible transmission/notification modes based on a survey of their targeted recipients. The end user company or agency would then use this survey to select the appropriate parameters to customize the alert notification system as specified. In addition, the company or agency could also allow the recipient, through the website as shown in FIG. 8, to select a particular mode of transmission 102 to a mobile device or web site, depending on the availability of the receiving resource and the location of the individual emergency responder. For example, if the individual emergency responder knew he or she would be traveling to a location without cell phone coverage, but where Internet access was assured, the emergency responder could go to the web site and select the web as the preferred avenue of transmission, or select redundant means of transmission.

In another example, a new transmission/notification mode in the future could include satellite radio notification, whereby the audio is downloaded directly to a satellite radio receiver in a car or home. The recipient could view the alert on the satellite radio receiver, enter an appropriate code on a keypad, and then listen to the audio message, without picking up a phone, viewing an email or going to a web site.

With the flexibility and configurability of the present alert system described herein, such a new transmission/notification mode could be accommodated without adding new hardware to the basic communications system.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. A configurable alert notification communications system, comprising;
an audio receiver for detecting a discrete signal transmitted by a message dispatch system;
a computer connected to the audio receiver for recording, in a first format, an audio message associated with the discrete signal;
means for converting the audio message in the first format to at least one of a plurality of dissimilar formats as specified by an end user company, wherein the means for converting is further adaptable to convert the first format to a new format different from the dissimilar formats as specified by the end user company;
means for distributing the first format, and the at least one dissimilar format or the new format, to corresponding server means configured for accepting each of the formats; and
means for transmitting one or more of the formats from the server means to corresponding receiving means, wherein the receiving means are specified by the end user company and selected by a recipient.

2. The system of claim 1, further including means for selecting the first format, dissimilar formats and new format.

3. The system of claim 2, wherein the means for converting is updated by downloading and storing a new audio conversion algorithm to the computer.

4. The system of claim 1, wherein the discrete signal is a two-tone sequential signal.

5. The system of claim 4, wherein the plurality of other dissimilar formats in the conversion step comprise one or more of MP3, GSM, TDMA, CDMA, and digital broadcast satellite formats.

6. An alert notification communications process, comprising;
detecting a discrete signal transmitted by a message dispatch system;
recording an audio message associated with the discrete signal in a first format;
converting the audio message in the first format to at least one of a plurality of other dissimilar formats specified by an end user company, or converting the audio message to a new format different from the dissimilar formats as specified by the end user company;
distributing the first format, and the at least one dissimilar format or the new format, to corresponding server means configured for accepting each of the formats; and
transmitting one or more of the formats from the server means to corresponding receiving means, wherein the receiving means are specified by the end user company and selected by a recipient.

7. The communications process of claim 6, wherein the discrete signal detected in the detecting step comprises a two-tone sequential signal.

8. The communications process of claim 7, wherein the first format in the recording step comprises a WAV format.

9. The communications process of claim 8, wherein the plurality of other existing dissimilar formats in the conversion step comprise one or more of MP3, GSM, TDMA, CDMA, and digital broadcast satellite formats.

10. The communications process of claim 6, further including selecting the first format, dissimilar formats and new format before the detecting step.

11. The communications process of claim 6, further including providing a new audio conversion algorithm corresponding to the new format before the converting step.
